(19) United States
(12) Patent Application Publication
(10) Pub. No.: US 2018/0310580 A1
(43) Pub. Date: Nov. 1, 2018

(54) METHOD FOR THE TREATMENT, IN PARTICULAR TEMPERATURE CONTROL, HEATING AND/OR COOLING, OF LIQUID FOOD FOR ANIMALS

(71) Applicant: Martin Forster, Engen (DE)

(72) Inventor: Martin Forster, Engen (DE)

(21) Appl. No.: 15/772,960

(22) PCT Filed: Nov. 2, 2015
(86) PCT No.: PCT/EP2016/076446

§ 371 Date: May 2, 2018

(30) Foreign Application Priority Data
Nov. 2, 2015 (DE) 10 2015 118 731.0

(51) Int. Cl. A23C 3/05; A23C 9/20; A01J 7/00; A01K 9/00; A01J 11/00

(52) U.S. Cl. CPC A23C 3/055; A23C 9/206; A23C 3/02; A01K 9/005; A01J 11/00; A01J 7/00

(57) ABSTRACT

In a device for freezing milk, in particular colostrum (3), in a container (5) comprising a temperature control element (10), the temperature control element remains in the frozen milk.

This invention relates to a device for freezing milk, especially colostrum, in a container with a temperature control element.

### State of Technology

When calves are fed, the milk which is used has frequently been pasteurized for storage, cooled down or even frozen. This invention relates primarily, but not exclusively, to colostrum. Colostrum is the first milk provided by the mother cow and is particularly rich in vitamins, minerals, special proteins, antibodies etc. It is fed to young animals to boost the immune system. But it also contains harmful germs.

These germs are killed off with pasteurization devices, for example, as described in WO 2004/089069 A1. For the pasteurized milk to not be contaminated with germs again, it must be cooled down to a germ-inhibiting temperature in suitable storage containers. However, this approach has the disadvantage that the cooled milk must be heated to feeding temperature again to feed animals with the pasteurized milk.

A device exists which fills the colostrum directly after milking into a four-liter plastic bag with plastic basket via a funnel. The bag is closed, labeled and frozen in a freezer specifically modified for this purpose.

The basket containing the plastic bag is immersed into a water bath to thaw the colostrum. Due to constant motion of the basket in the warm water, the colostrum is thawed within 15 minutes.

The problem of this invention is the fact that the milk is filled into a funnel after milking and is therefore exposed to the air and various germs. Germs which are meant to be killed off. Dangerous bacteria may then enter the milk. These bacteria are resistant enough to withstand temperatures of up to 60° C.

This invention can also be used for pasteurization. To do so, the basked containing the plastic bag is heated in the water bath for one hour and then frozen.

Another invention, described in DE10 2010 060 715 A1 and in WO2012/069158, intends for the colostrum after milking to be filled directly into a container and then frozen. To heat up the milk for the calf, DE 10 2006 054 215 A1 suggests pressurizing the liquid food in the container directly with a temperature-controlled gaseous medium. For this purpose, a steam distributor blows steam into the container. During this process, the milk is thawed or heated in several areas at once.

Another disadvantage of the inventions is the fact that the colostrum must be filled into a feeding bottle after thawing. Germs may contaminate the milk during this process as well.

Task

The task of the following invention is to enable the treatment in general and the heating and/or pasteurization or cooling process of the liquid food, especially milk, to take place faster while also facilitating the cleaning process of the container. Colostrum, in particular, is to be treated from the milking system to consumption by the calf in such a way, that it is subjected to as few germs as possible while retaining all the nutrients required by the calf. The entire device should be effective quickly and cost-efficient.

Solution

One aspect of the solution is the fact that the temperature control element remains in the frozen milk.

In the context of the invention at hand, a temperature control element is understood to be any component capable of cooling down milk to such a temperature that it can be stored in frozen condition. On the other hand, the temperature control element should also be capable of heating up the milk, as it is to remain in the milk. To this end, a heat exchanger can be used which allows for low as well as high temperatures. A conceivable solution included in the invention at hand is the option of two separate elements within one temperature control element—one for cooling down the milk and one for heating it up. The part of the temperature control element assuming the heating duties can also be a kind of immersion heater operated electronically. A steam distributor, as described in WO 2012/069158, can also be used.

The temperature control element, or the part thereof responsible for cooling down, preferably has a cavity. This cavity is located inside a suitable installation which forms the cavity. Several options are conceivable to this end and should be included in the invention. A device like an immersion heater is the preferred solution. This cavity is then formed spirally. The spiral can fill out the entire container or be in its center only. It is also possible to place several smaller spirals inside the container. Both versions enable a good distribution of heat or cold.

The installation forming the cavity may also be rod-shaped. One or several hollow rods could be located inside the container to hold a tempering medium.

The cavity, whether spiral-shaped or rod-shaped, has a filler hole through which it can be filled with a tempering medium, preferably water. The filler hole is preferably located outside of the container, ideally adjacent to the top surface of the container. This set-up has the advantage that the container does not have to be open to insert the temperature control device, leading to less germs being able to contaminate the milk through the incoming air when the container is opened.

An outlet is installed at the end of the cavity, so that the tempering medium can be discharged from the cavity. It is located outside of the container, ideally also above the container. This has the advantage that the tempering medium can also be discharged during the heating process and new tempering medium can be added through the filler hole. The tempering medium itself loses heat/cold as it transfers it to the environment, in this case milk. The entire device with cavity, filler hole and outlet is ideally designed as a single unit which can be inserted into or removed from the container.

In any case, the device remains in the container and is preferably used for thawing the milk later. The great advantage is the fact that less germs can contaminate the milk here as well. Because the milk does not have to be filled into a separate container for freezing after it was heated for pasteurization. Less transfers mean less contamination.

Especially in the case of colostrum, a gentle heating process is quite significant. In contrast to normal milk, heat nests tend to form when colostrum is thawed or heated which may damage the colostrum. When colostrum is heated in a microwave, for example, it has been determined that important gamma globulins are destroyed through overheating. The invention at hand significantly minimizes overheating and/or the formation of heat nests.

Another great advantage of this invention is the fact that the device can be directly connected to the milking system. As a result, the process remains in a completely closed cycle which produces high-quality milk. Germ growth is reduced or stopped completely.

Another solution for the problems mentioned above is another example version of the invention at hand, for which protection is sought separately. In this variant, the container is equipped with a lid with teat. That way, the colostrum or other milk can be directly fed to a calf.

The lid can be placed on the container in any way, and the container rim is to be equipped with an inside or outside thread and the lid with the corresponding counter-thread.

The teat is ideally eccentrically located on the lid to facilitate the drinking process for the calf as well as the handling of the container as much as possible. It is conceivable for the teat to be a fixed attachment or removable from the lid, simplifying the cleaning process.

The lid is also equipped with a handle, making it easier to hold the bottle. However, the handle can also be removed, for cleaning purposes, for example. An advantage of an outside handle is the fact that it cannot transfer germs into the inside of the container. Germs tend to be present at the transfer point from container to handle, a problem which has been remedied in this approach. This especially applies when the handle is an integrated part of the container. In general, the handle is hollow, so that it fills with milk when the container is filled. Cleaning that kind of hollow handle is extremely difficult. Another option would be to simply install the handle on the wall of the container. With this solution, it would also not be possible for milk to enter a hollow handle.

The container itself has a large opening, making the cleaning process of the inside significantly easier. The container is to be designed as a polygon in its profile to break a possible vortex flow of the milk, for example during thawing.

This simple container can of course preferably be used for treating colostrum as well. In this case, the device described above is inserted to temper the milk. Ideally, the device remains in the container, even when the colostrum is frozen. For thawing, a suitable tempering medium is filled into the device to thaw the milk and feed it to the calf. The entire invention leads to a closed cycle, minimizing the possibilities for germs to contaminate the milk.

In another version of the invention, the container is inserted into another container, forming a chamber between the two. In this example, a tempering medium could be added, supporting a thawing process from the outside. It is then conceivable to add the tempering medium back to the cycle using a circulating pump. That way, the cycle remains closed.

The inner container containing the milk could also be equipped with an outlet into the outer container, so that thawed milk could flow into the outer container. In this example, the thawed milk is returned to the inner container, either through a pump or through spillover, so that it can support the thawing process of the remainder of the milk.

Furthermore, the container could be equipped with a cushion whose volume can be adjusted with pulses. This cushion would have to be installed near the bottom of the container, so that the already thawed milk is pulsated from the bottom to the top, which also supports the thawing process. The cushion could be an elastic pouch, for example, connect to a pump, which pushes air into and out of the pouch. Several options are conceivable to this end and should be included in the invention.

Another version of the invention, for which independent protection is sought, ideally applied in combination with the temperature control element, regards a process for treating and tempering, heating and/or cooling liquid food for animals, especially milk for young animals, for feeding and/or pasteurizing such liquid food, for example milk, which is placed into a container and treated with steam added to the liquid food in pulses.

The pulsating steam prevents uniform movement in the food while being treated. It creates a turbulence which significantly improves the mixing process with steam. This approach leads to faster pasteurization, for example. In case the food must be reheated, ice bridges forming during the reheating process are destroyed much faster, for example. This also results in faster and more uniform heating.

The addition of another gas, especially air, further optimizes the addition of steam, as it increases the turbulence in the food. The advection of the steam to the food components is increased.

Examples of devices with pulsating addition of steam are DE 10 2006 054215 A1 and DE 10 2010 060715 A1. If such devices are used for an inner container, for example, which has been inserted into an outer container, they can be used in the inner container as well as in the space between inner and outer container.

### DESCRIPTION OF FIGURES

Additional benefits, features, and details of the invention can be found in the following description of preferred design examples and as per drawing. It shows in

FIG. 1 a side view of the invented device for treating milk;

FIG. 2 a block diagram of the invented device as per FIG. 1;

FIG. 3 a side view of another design example of the invented device;

FIG. 4 a perspective view of a lid of the invented device as per FIG. 3;

FIG. 5 a side view of another design example of the invented device;

As per FIG. 1 and the invention at hand, device V contains a container 5 with one or several installations therein 10 to temper the content of the container 5 with one or several cavities 2. The cavity 2 may be formed in different shapes and sizes. Ideally, this cavity 2 is spiral-shaped in the preferred design example and has a filler opening 1 as well as an outlet 4.

A temperature sensor 6 is allocated to the container as well. The temperature in the inside of the container 5 is measured through the temperature sensor 6.

In accordance with the design example of the invention as shown in FIG. 1, the filler hole 1 and outlet 4 should be located on the same side of the container. That way, the device 10 can be easily inserted into and removed from the container 5. It is also conceivable to design the device differently, with the filler hole 1 and the outlet 4 in a different location on the container.

The cavity 2 is intended to hold a tempering medium. Any medium suitable for temperature exchange is suitable to be used as tempering medium. For the sake of simplicity, water is naturally the preferred medium.

This is the functionality of the invention at hand:

In a preferred design example, the container 5 is used to treat colostrum. The colostrum is to be pasteurized, heated to 60° C., for example. To this end, the colostrum is filled into the container 5 and the device 10 is inserted into the container 5. Then, the corresponding tempering medium is filled into the cavity 2 and the colostrum pasteurized.

After that, a cooler tempering medium can lower the temperature, so that it is available for consumption immediately. Temperature sensor 6 determines when the colostrum 3 has reached the desired temperature. Once that temperature has been reached, the device 10 can be removed from the container 5 and/or the tempering medium can be discharged from outlet 5. The colostrum 3 can now be fed to the calf.

If the colostrum does not need to be available immediately for drinking, it can be frozen as well. This is achieved in combination with device 10. To prepare the milk for drinking, a warm tempering medium is filled into cavity 2. In practical applications, it was determined that the invented device 10 enables fast and uniform thawing of the colostrum. Warm water in the cavity 2, for example, transfers its heat to the colostrum 3 and gently heats it. To thaw the colostrum 3 as fast as possible, cooled water can be discharged through the outlet 4 and new, warmer water can be added through the filler hole 1. This process can be repeated until the colostrum 3 has reached the desired temperature for consumption. It can then be fed to the animal.

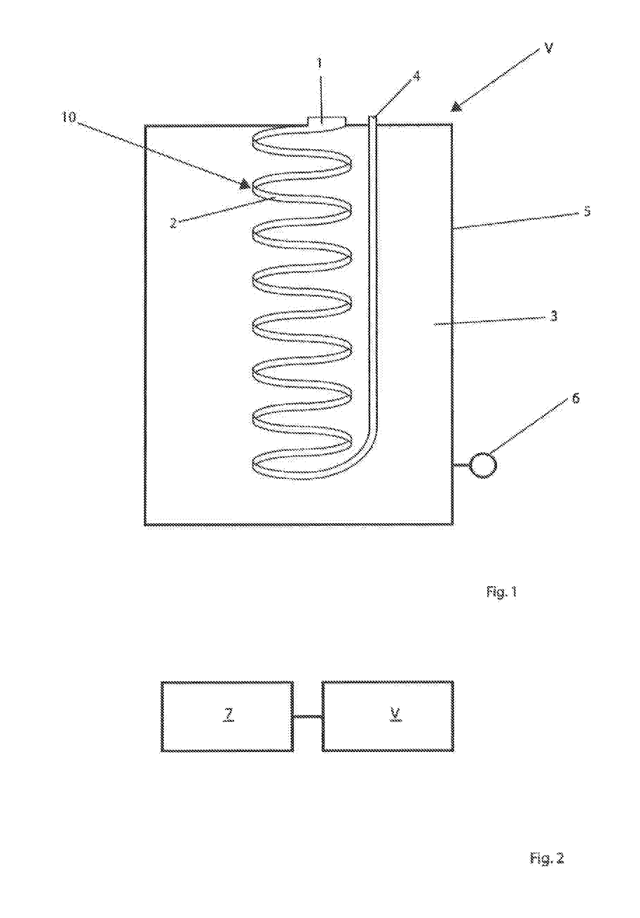

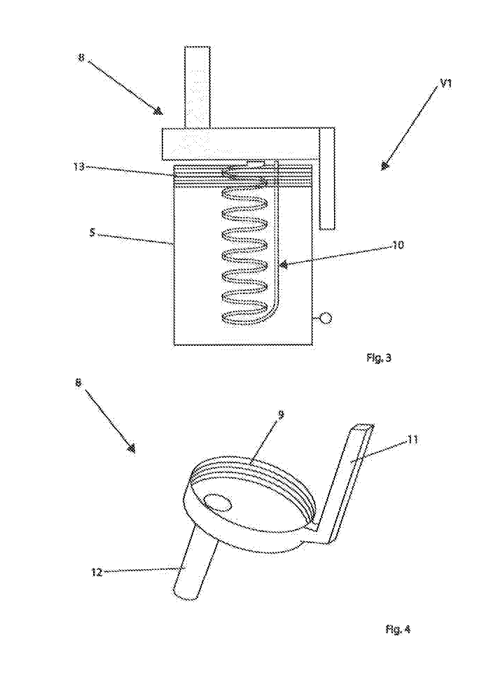

The device V can also be applied in direct combination with a milking system 7. For this purpose, the colostrum can be guided from the milking system 7 directly into the container 5, as shown in FIG. 2. After that, a cooling medium is administered through the filler hole 1 which transfers its cold to the colostrum and gently freezes it. Or the cold is administered from the outside to freeze the device 10 together with the milk.

The temperature sensor 6 checks the freezing progress of the colostrum. The already heated cooling medium can also be discharged through the outlet 4 and new medium added through the filler hole 1.

FIG. 3 shows another design example of the device V1 at hand. In this example, the container 5 is equipped with an outer thread 13. A lid 8 is screwed on this outer thread 13.

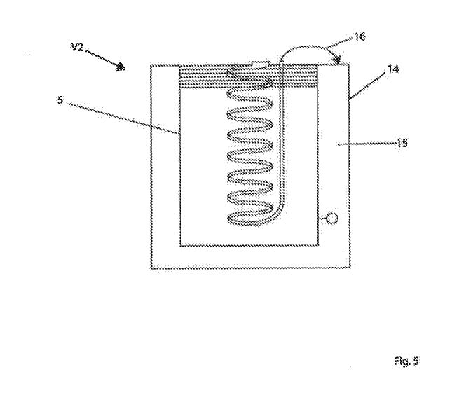

FIG. 4 presents a perspective view of the lid 8. This lid 8 is equipped with a thread 9 which will be referred to as inner thread 9 as it is located on the inside in the corresponding design example.

Furthermore, the lid 8 is equipped with a handle 11 and a teat 12, both of which can be attached to the lid or removable. It is preferred for the handle to be attached to the lid and outside facing the container 5.

The teat 12 is eccentrically structured to simplify the suction process for the calf. However, it can be in the center as well. That way, the calf can be fed directly after the colostrum has thawed without it having to be refilled into a suction bottle.

As per FIG. 5, a device V2 is also equipped with an outside container 14, with a chamber 15 between the container 5 and the outside container 14, into which the tempering medium can be transferred, as indicated by the arrow 16. It is then conceivable to add the tempering medium back to the cycle using a circulating pump.

1. Device for freezing milk, especially colostrum comprising:
a container with a temperature control element;
a lid with a teat configured for milk consumption to young animals, especially calves, wherein the temperature control element is usable for freezing and thawing the milk and can remain in the frozen milk after the freezing.

2. Device as per claim 1, further wherein the temperature control element is a heat exchanger.

3. Device as per claim 1, further wherein the temperature control element is a kind of immersion heater operated electronically.

4. Device as per claim 1, further comprising a cavity located and remaining inside the container, wherein the cavity can be filled with treatment medium.

5. Device as per claim 4, further wherein the cavity is spiral-shaped.

6. Device as per claim 4, further wherein the cavity has a filler hole.

7. Device as per claim 6, further wherein the filler hole is located outside of the container.

8. Device as per claim 4, further wherein the cavity is equipped with an outlet.

9. Device as per claim 8, further wherein the outlet is located outside of the container.

10. Device as per claim 9, further wherein the outlet and the filler hole are located on the same side of the container.

11. Device as per claim 4, further wherein the cavity is located inside an immersion heater-like device which can be inserted into and removed from the container.

12. Device as per one of the claims 1, further wherein the device can be directly coupled to a milking system.

13. Device as per claim 1, further wherein the container is equipped with an outer and/or inner thread at an upper edge.

14. (canceled)

15. Device as per claim 1, further wherein the teat is eccentric.

16. Device as per claim 1, further wherein the teat is a fixed part of the lid or can be removed.

17. Device as per claim 1, further comprising a handle that has been attached to the lid.

18. Device as per claim 17, further wherein the handle is a fixed part of the lid or can be removed.

19. Device as per claim 1, further wherein the lid is equipped with a thread.

20. Device as per claim 1, further comprising an outer container located around the container to form a chamber.

21. Device as per claim 20, further wherein a tempering medium can be transferred to the chamber.

22. Device as per claim 1, further comprising at least one element that is inserted into the container and has a volume which can be modified through pulsation.

23. Process for freezing and thawing of milk, especially colostrum, in a container, comprising:
freezing and thawing the milk with a temperature control element;
wherein, the temperature control element remains in the frozen milk after the freezing.

24. (canceled)
